(19) United States
(12) Patent Application Publication
(10) Pub. No.: US 2008/0258906 A1
(43) Pub. Date: Oct. 23, 2008

(54) Integration System, System Integration Method and Computer Readable Medium Having System Integration Program

(75) Inventor: Naoyuki Okita, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/661,720

(22) PCT Filed: Aug. 31, 2005
(86) PCT No.: PCT/JP2005/015917

§ 371 Date: Feb. 19, 2008

(30) Foreign Application Priority Data
Sep. 2, 2004 (JP) 2004-255080

(51) Int. Cl. G08B 21/00

(52) U.S. Cl. 340/532

(57) ABSTRACT

A safety controller includes a function block and a mapping block. The function block executes a function inherent to the safety controller. The mapping block converts data used in a control system among data handled by the function block into a data format which can be directly handled by the control system and also assigns a common tag to these data. Also, the mapping block performs calculation based on data handled by the function block and outputs a signal instructing whether to transmit a process alarm according to the calculation result. Also, the mapping block assigns a common tag to this signal. As a result, in the control system, it is possible to recognize that these data groups are related to one another.

### TECHNICAL FIELD

The present invention relates to an integration system, a system integration method and a system integration program for integrating plural systems.

### BACKGROUND ART

A control system capable of widely monitoring and manipulating a plant by using a terminal has been known. Also, a security system for ensuring safety of a plant by, for example, detecting abnormality occurred in the plant and shutting down the corresponding apparatus has been known.

A technique for performing communication between a control station of a distributed control system and a field bus device through a mapping block is described in JP-A-2004-29910.

### DISCLOSURE OF THE INVENTION

### Problems that the Invention is to Solve

However, when a control system and a security system are made to function as the mutually independent separate systems, independent monitoring or manipulation with respect to the two systems is required, so that a load of operation increases. Because of this, it is contemplated to decrease the load of operation by integrating the two systems. However, when the control system and the security system adopt different system infrastructures, a special mechanism for data exchange between both the systems is required.

FIG. 6 is a block diagram showing a method for making connection between a control system 100 and a safety controller 106 constructing a security system by using a gateway. While the safety controller 106 is used in a system compliant with IEC61131-3 standard, the control system 100 is a system which is not compliant with this standard. As shown in FIG. 6, the safety controller 106 receives a signal of a sensor 161 and sends out a signal for closing a valve 162 as necessary. Consequently, safety of a plant is ensured by shutting down an apparatus provided with the valve 162. On the other hand, the control system 100 for controlling the whole plant is provided with a gateway 101, and the gateway 101 performs processing of conversion, etc., of a data format and thereby, data can be sent and received between the control system 100 and an application execution function 107 of the safety controller 106.

Also, FIG. 7 is a block diagram showing a method for making connection between a control system 100 and a safety controller 106 by using a communication system. In an example of FIG. 7, a function similar to a gateway is given to a communication function 108 of the safety controller 106 and a communication function 102 disposed in the control system 100.

However, in these methods, it is necessary to give a communication function to the control system 100 or dispose a gateway which is hardware in order to connect the safety controller 106, and there is a problem that system construction cost increases. Also, it is necessary to map data used in an application of the safety controller 106 as input/output data one by one, and then engineering cost increases. Further, there is a problem that respective data are allocated to different tags though such a data group should be gathered as one group primarily. As a result of this, in the case of referring to the data group from the side of the control system 100, it is necessary to combine plural tags and then an increase in operation cost is caused.

FIG. 8 is a diagram showing an operation example of giving a process alarm in a configuration of FIG. 6. This example considers an application for giving a process alarm in a control system 100 when a value of a signal of a sensor 161 exceeds a first upper limit value or a second upper limit value and exceeds a first lower limit value or a second lower limit value. In spite of such a simple application, a signal “HI” indicating whether or not an inputted process value “PV” exceeds a first upper limit value, a signal “HH” indicating whether or not an inputted process value “PV” exceeds a second upper limit value, a signal “LO” indicating whether or not an inputted process value “PV” falls below a first lower limit value, a signal “LL” indicating whether or not an inputted process value “PV” falls below a second lower limit value, and a signal “HI alarm”, a signal “HH alarm”, a signal “LO alarm” and a signal “LL alarm” indicating the presence or absence of alarms corresponding to each of the threshold values must be separately defined, thereby engineering becomes complicated. Also, signals that should be primarily gathered as one group are allocated to different tags, and mutual relation is lost. Because of this, these signals cannot be accessed as one data group. Also, for example, the signal “HI” and the signal “HI alarm”, the signal “HH” and the signal “HH alarm”, the signal “LO” and the signal “LO alarm”, and the signal “LL” and the signal “LL alarm” should be primarily handled as pair signals. However, in this example, separate tags are assigned to the respective signals, so that related data cannot be accessed easily even when a process alarm is generated. Such a problem arises similarly in the case of replacing a gateway with a communication function (FIG. 7).

An object of the invention is to provide an integration system, a system integration method and a system integration program capable of integrating two systems while maintaining ease of use similar to that at the time of using a single system.

### Means for Solving the Problems

The invention provides an integration system for integrating a first system and a second system, wherein the first system comprises:

a function block for executing a function of the first system; and

a mapping block for converting data to be used in the second system among data handled by the function block into a data format which can be directly handled by the second system, and outputting the data by making the data be related to one another.

According to this integration system, a function of a first system is executed by using a function block, so that data handled by the function block can be freely selected to be supplied to a second system. As a result of this, both the systems can be integrated without sacrificing ease of use of the second system. Also, a mapping block outputs data used in the second system by making the data be related to one another, so that these data can be handled as data related to one another in the second system, and thereby the necessary data can be accessed easily.

In the integration system, the mapping block performs calculation using the data handled by the function block and outputs the calculation result in the data format which can be directly handled by the second system.

In this case, the mapping block can be made to fulfill a different function without requiring hardware or complicated engineering.

The invention provides an integration system for integrating a first system and a second system, wherein the first system comprises:

a function block for executing a function of the first system; and

a mapping block for performing calculation using data handled by the function block and outputting the calculation result in a data format which can be directly handled by the second system.

According to this integration system, a function of a first system is executed by using a function block, so that data handled by the function block can be freely selected to be supplied to a second system. As a result of this, both the systems can be integrated without sacrificing ease of use of the second system. Also, a mapping block performs calculation using data handled by the function block and outputting a calculation result in a data format which can be directly handled by the second system, so that the mapping block can be made to fulfill a different function without requiring hardware or complicated engineering.

In the integration system, the second system may be a control system for controlling a plant. Also, in the integration system, the first system may be a system for ensuring safety of the plant.

The invention provides a system integration method for integrating a first system and a second system, the system integration method comprising the steps of:

executing a function of the first system by using a function block; and

converting data to be used in the second system among data handled by the function block into a data format which can be directly handled by the second system, and outputting the data by making the data be related to one another.

According to this system integration method, a function of a first system is executed by using a function block, so that data handled by the function block can be freely selected to be supplied to a second system. As a result of this, both the systems can be integrated without sacrificing ease of use of the second system. Also, data used in the second system is outputted by making the data be related to one another, so that these data can be handled as data related to one another in the second system, and thereby the necessary data can be accessed easily.

In the system integration method, it may comprise the step of:

performing calculation using the data handled by the function block and outputting the calculation result in the data format which can be directly handled by the second system.

In this case, a different function can be fulfilled without requiring hardware or complicated engineering.

The invention provides a system integration method for integrating a first system and a second system, the system integration method comprising the steps of:

executing a function of the first system by using a function block; and

performing calculation using data handled by the function block and outputting the calculation result in a data format which can be directly handled by the second system.

According to this system integration method, a function of a first system is executed by using a function block, so that data handled by the function block can be freely selected to be supplied to a second system. As a result of this, both the systems can be integrated without sacrificing ease of use of the second system. Also, calculation using data handled by the function block is performed and a calculation result is outputted in a data format which can be directly handled by the second system, so that a different function can be fulfilled without requiring hardware or complicated engineering.

In the system integration method, the second system may be a control system for controlling a plant. Also, in the system integration method, the first system may be a system for ensuring safety of the plant.

The invention provides a system integration program for executing a system integration method for integrating a first system and a second system, the system integration program allowing a computer to execute the steps of:

executing a function of the first system by using a function block; and

converting data to be used in the second system among data handled by the function block into a data format which can be directly handled by the second system, and outputting the data by making the data be related to one another.

According to this system integration program, a function of a first system is executed by using a function block, so that data handled by the function block can be freely selected to be supplied to a second system. As a result of this, both the systems can be integrated without sacrificing ease of use of the second system. Also, data used in the second system is outputted by making the data be related to one another, so that these data can be handled as data related to one another in the second system, and thereby the necessary data can be accessed easily.

The system integration program allows a computer to execute the step of:

performing calculation using the data handled by the function block, and outputting the calculation result in the data format which can be directly handled by the second system.

In this case, a different function can be fulfilled without requiring hardware or complicated engineering.

The invention provides a system integration program for executing a system integration method for integrating a first system and a second system, the system integration program allowing a computer to execute the steps of:

executing a function of the first system by using a function block; and

performing calculation using data handled by the function block, and outputting the calculation result in a data format which can be directly handled by the second system.

According to this system integration program, a function of a first system is executed by using a function block, so that data handled by the function block can be freely selected to be supplied to a second system. As a result of this, both the systems can be integrated without sacrificing ease of use of the second system. Also, calculation using data handled by the function block is performed and a calculation result is outputted in a data format which can be directly handled by the second system, so that a different function can be fulfilled without requiring hardware or complicated engineering.

### EFFECT OF THE INVENTION

According to the integration system, the system integration method and the system integration program described above, a function of a first system is executed by using a function block, so that data handled by the function block can be freely selected to be supplied to a second system or calculation can be executed by using these data freely. As a result of this, the first system and the second system can be organically integrated without sacrificing ease of use of the second system.

### BRIEF DESCRIPTION OF THE DRAWINGS

FIG. 1 is a block diagram showing a configuration of a control system to which an integration system of the invention is applied.

FIG. 2 is a block diagram showing a function of a safety controller.

FIG. 3 is a diagram showing an operation example of the safety controller and the control system.

FIG. 4 is a diagram showing a display screen created based on data obtained from a mapping block.

FIG. 5 is a flowchart showing a procedure of management and generation of a process alarm in the mapping block.

FIG. 6 is a block diagram showing a method for making connection between a safety controller and a control system by using a gateway.

FIG. 7 is a block diagram showing a method for making connection between a safety controller and a control system by using a communication system.

FIG. 8 is a diagram showing an operation example of giving a process alarm.

### DESCRIPTION OF REFERENCE NUMERALS AND SIGNS

6 SAFETY CONTROLLER (FIRST SYSTEM)
7 FUNCTION BLOCK
8 MAPPING BLOCK
100 CONTROL SYSTEM (SECOND SYSTEM)

### BEST MODE FOR CARRYING OUT THE INVENTION

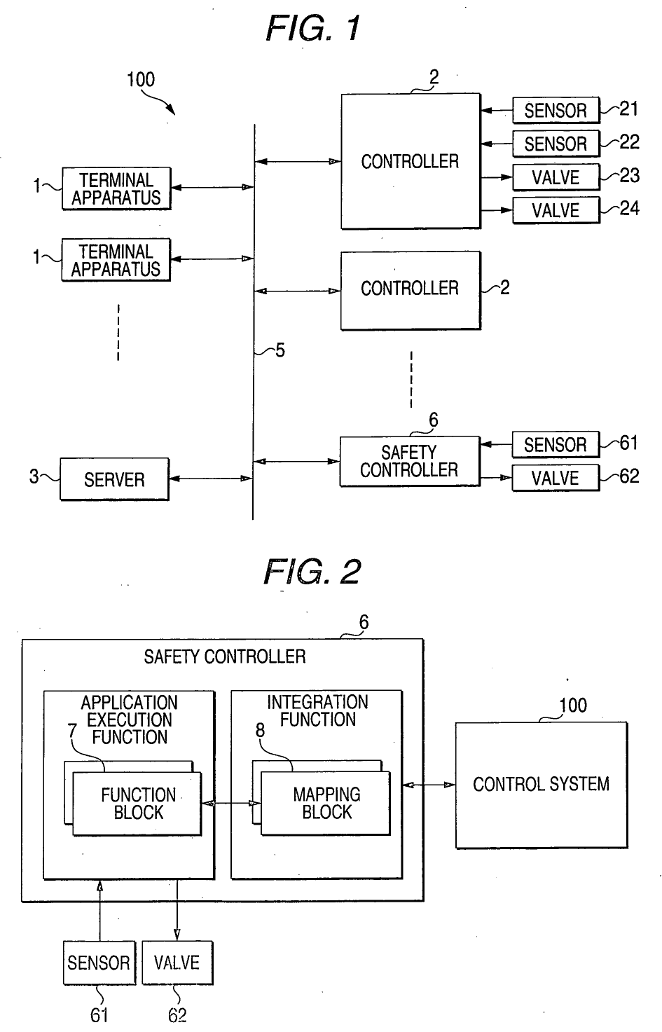

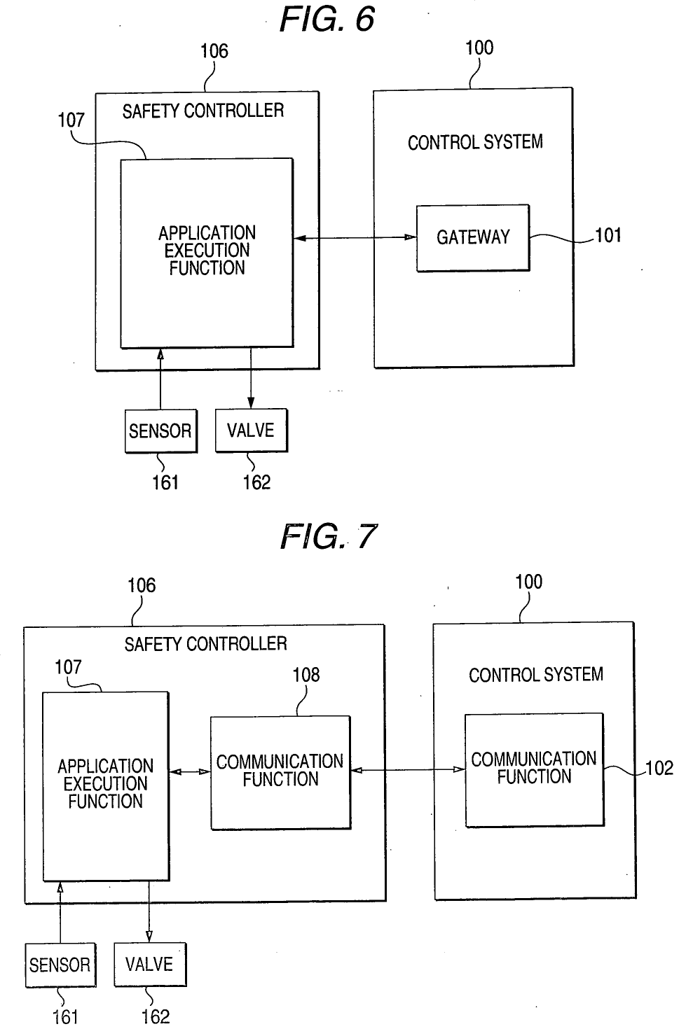

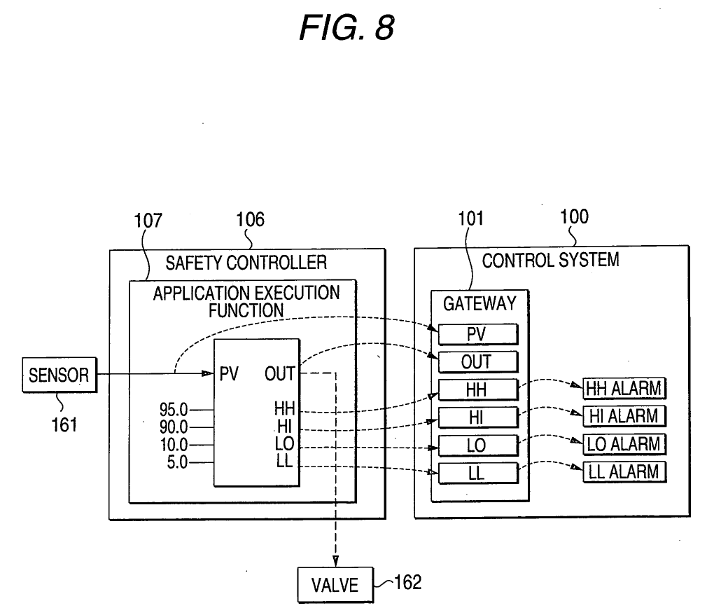

One embodiment of an integration system according to the invention will be described below with reference to FIGS. 1 to 6. The present embodiment shows an example of applying the invention to a control system for controlling a plant.

FIG. 1 is a block diagram showing a configuration of a control system to which an integration system of the invention is applied. As shown in FIG. 1, a control system (second system) 100 includes terminals 1 for accepting manipulation of an operator while enabling monitoring by the operator, controllers 2 for controlling each part of a plant, and a server 3 for controlling the whole control system 100. The terminals 1, the controllers 2 and the server 3 are mutually connected by a communication line 5. Sensors 21, 22, valves 23, 24, etc., disposed in the plant are connected to the controllers 2.

In the control system 100, automatic operation of the plant can be performed by controlling each part of the plant through the controllers 2. Also, data of each part of the plant is transferred to the terminals 1 through the controllers 2 and an operator can monitor the whole plant through the terminals 1. Further, each part of the plant can be controlled manually by manipulations to the terminals 1.

Also, as shown in FIG. 1, a safety controller 6 constructing a security system (first system) is connected to the communication line 5. A sensor 61, a valve 62, etc., disposed in the plant are connected to the controller 6.

FIG. 2 is a block diagram showing a function of the safety controller 6. As shown in FIG. 2, the safety controller 6 includes a function block 7 for fulfilling an application execution function, and a mapping block 8 for fetching necessary data from among data handled by the function block 7 and converting the data into a data format which can be used in the control system 100. The function block 7 is prepared for every function, and the mapping block 8 is disposed in correspondence with each of the function blocks 7. The function block 7 and the mapping block 8 are implemented by using a program for making the controller 6 work.

Next, an operation of the safety controller 6 will be described.

The function block 7 executes the function inherent to the safety controller 6. The function block 7 gives a alarm and also sends out a necessary signal to the valve 62, etc., when information from the sensor 61, etc., is monitored and abnormality is detected. For example, by sending out a signal for closing the valve 62, etc., at the time of detecting the abnormality, the corresponding apparatus is shut down and safety of the plant is ensured. Also, for example, fire is detected and water spraying for fire fighting is executed. Such a function is executed independently of the control system 100, and the control system 100 does not have an adverse influence on the operation of the safety controller 6.

On the other hand, the mapping block 8 functions as an element for fulfilling an integration function of making integrated connection between the control system 100 and the safety controller 6. The mapping block 8 fetches data used in the control system 100 among the data handled by the function block 7. Also, the mapping block has a function of converting that data into a data format which can be recognized by the control system 100 and passing the data to the control system 100. In addition, actually, after data of the function block 7 is stored in a temporary buffer, the data is fetched in the mapping block 8. Further, the mapping block 8 has a function of performing calculation using data handled by the function block 7 and outputting a calculation result in a data format which can be recognized by the control system.

In the present embodiment, information from the safety controller 6 can be handled in the control system 100 by integrating the safety controller 6 and the control system 100. As a result of this, the information from the safety controller 6 can be monitored in the terminal 1, and integrated monitoring of the whole plant including the safety controller 6 can be performed without preparing another terminal, etc. Also, information obtained through the safety controller 6 can be used in the controllers 2 or the server 3.

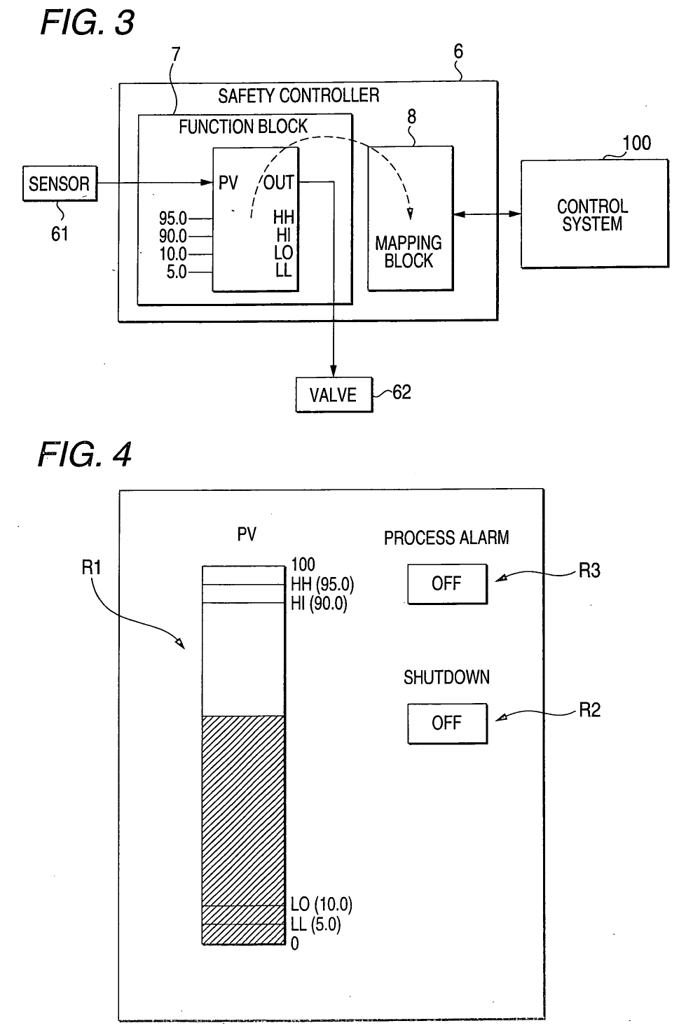

An operation example of the control system 100 and the safety controller 6 will be described below with reference to FIG. 3.

As shown in FIG. 3, in this example, the function block 7 compares a value of a process value “PV” obtained from the sensor 61 with a first upper limit value (90.0), a second upper limit value (95.0), a first lower limit value (10.0) and a second lower limit value (5.0). Then, the function block 7 outputs a result of comparison between the process value “PV” and the first upper limit value as a signal “HI” and outputs a result of comparison between the process value “PV” and the second upper limit value as a signal “HH”. Also, a result of comparison between the process value “PV” and the first lower limit value is outputted as a signal “LO” and a result of comparison between the process value “PV” and the second lower limit value is outputted as a signal “LL”. The signal “HI”, the signal “HH”, the signal “LO” and the signal “LL” respectively take binary values. The safety controller 6 gives a necessary alarm according to values of the signal “HI”, the signal “HH”, the signal “LO” and the signal “LL”.

Also, the function block 7 performs predetermined calculation based on the process value “PV”, and outputs the signals “HI”, “HH”, “LO” and “LL” indicating whether or not a predetermined condition is satisfied. When the predetermined condition is satisfied, the signals “HI”, “HH”, “LO” and “LL” take values for instructing a closed state of the valve 62 and thereby, an apparatus targeted for monitoring of the sensor 61 is shut down. The contents of the predetermined condition can be set arbitrarily, and the apparatus can be shut down, for example, when the process value “PV” exceeds the second upper limit value and when the process value “PV” falls below the second lower limit value. Also, the condition can be set by using, for example, the present value of the process value “PV”, a speed of change in the process value “PV”, a history of change in the process value “PV” singly or in combination.

The above operation is executed as an operation of the safety controller 6 independent of the control system 100.

The mapping block 8 accesses data necessary for display in a monitor of the terminal 1 among a data group sequentially updated and handled by the function block 7, and sequentially fetches these data. Also, the fetched data is converted into a data format used in the control system 100. For example, the mapping block 8 sequentially fetches the process value “PV” and values of a signal “OUT”, the signal “HI”, the signal “HH”, the signal “LO” and the signal “LL” from the function block 7 and also converts a data format of their values into a data format of the control system 100. Also, the same tag allocated to the safety controller 6 is assigned to these values, and these values are presented as mutually associated data. Therefore, in the control apparatus 100, these data are recognized as a series of data to which the same tag is assigned, that is, data related to one another.

In the control system 100, one tag is allocated to each of the controllers 2. Then, a method for recognizing data related to each of the controllers 2 as mutually associated data depending on the tag is adopted. Therefore, by specifying a tag allocated to a particular controller 2, a data group related to its controller 2 can be accessed. Then, by specifying a tag allocated to the safety controller 6, all the data related to the safety controller 6 can be accessed. Thus, in the control system 100, a data group related to the safety controller 6 is handled in a manner similar to a data group related to one controller 2 within the control system 100.

FIG. 4 shows a display screen created based on data obtained from the mapping block 8 of the safety controller 6. For example, an operator specifies a tag allocated to the safety controller 6 and thereby, such a screen can be displayed on a monitor of the terminal 1. As shown in FIG. 4, an area R1 in which the present process value “PV” is graphically displayed is disposed on the monitor of the terminal 1, and a relation among a first upper limit value, a second upper limit value, a first lower limit value and a second lower limit value is visually shown. In an example of FIG. 4, the process value “PV” is shown by display of a bar graph shape extending in a vertical direction, and a situation in which the process value “PV” is located in the middle of the first upper limit value and the first lower limit value is shown. Also, information indicating whether or not an operation of shutdown is executed by the safety controller 6 is displayed in an area R2 of the monitor. This information is based on a value of a signal “HH”.

Next, the mapping block 8 has a function of generating a process alarm. The mapping block 8 performs predetermined calculation based on a process value “PV” fetched from the function block 7, and outputs an alarm signal when a predetermined condition is satisfied. This calculation is a calculation for determining whether or not a process alarm is to be sent out in the control system 100, and the process alarm is sent out independently of the function that is inherent to the safety controller 6. The condition of outputting the alarm signal can be determined independently of a condition of deciding a value of a signal “OUT” in the function block 7. The condition of outputting the alarm signal can be set arbitrarily and, for example, when the process value “PV” exceeds the first upper limit value or the second upper limit value and when the process value “PV” falls below the first lower limit value or the second lower limit value, the alarm signal can be outputted. Also, the condition can be set by using, for example, the present process value “PV”, a speed of change in the process value “PV”, a history of change in the process value “PV” singly or in combination.

The alarm signal is outputted in a data format handled by the control system 100 in a manner similar to other signals. Also, the alarm signal is presented as data to which the same tag as other values outputted from the mapping block 8, that is, the process value “PV” and values of the signal “OUT”, the signal “HI”, the signal “HH”, the signal “LO” and the signal “LL” is assigned. Therefore, in the control apparatus 100, the alarm signal can also be recognized as a signal included in a group of data related to the safety controller 6 in a manner similar to values of other signals. Therefore, for example, as shown in FIG. 4, the presence or absence of generation of the process alarm can be displayed in an area R3 of the monitor of the terminal 1 together with other information related to the safety controller 6.

In addition, a group of these data related to the safety controller 6 can be used in each part of the control apparatus 100 including the server 3 or the controllers 2 as well as the terminals 1. Also, the group of these data can be accessed properly by specifying a tag allocated to the safety controller 6.

Further, the mapping block 8 has a management function of a case where the process alarm is sent out. The mapping block 8 checks whether or not a check operation indicating that an operator recognizes that the process alarm is sent out is executed when the alarm signal is outputted. Then, when execution of the check operation is checked, the process alarm is stopped. Until execution of the check operation is checked, the process alarm is sent out continuously or repeatedly.

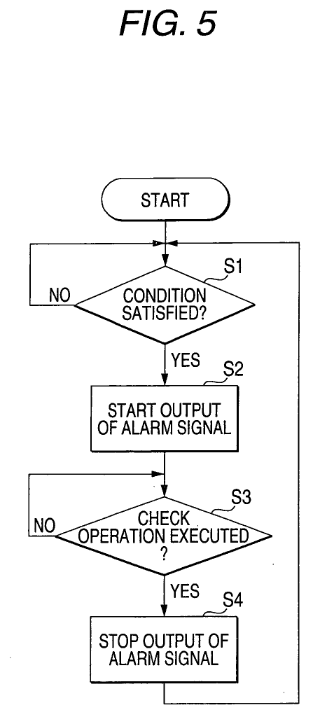

FIG. 5 is a flowchart showing a procedure of management and generation of the process alarm in the mapping block 8. In step S1 of FIG. 5, it is waited until a condition for outputting an alarm signal is satisfied and the flowchart proceeds to step S2. In step S2, an output of the alarm signal is started. Consequently, in the control apparatus 100, the process alarm is sent out, and that fact is displayed on the monitor of the terminal 1 (FIG. 4). Next, in step S3, it is waited until a check operation of an operator is executed through the terminal 1 and the flowchart proceeds to step S4. In step S4, an output of the alarm signal is stopped and the flowchart returns to step S1. Consequently, the process alarm in the control apparatus 100 is stopped, and a stop of the process alarm is reflected on display of the terminal 1.

In the present embodiment, thus, necessary functions are implemented without modifying the control system 100 by giving functions of management and generation of the process alarm to the mapping block 8. The management and generation of the process alarm are the functions provided in the controller 2 primarily, but in the present embodiment, the safety controller 6 is handled in a manner similar to the controller 2 by giving such functions to the safety controller 6.

As described above, in the integration system of the present embodiment, the safety controller 6 is made to function as a part of the control system 1 apparently by providing functions of the function block 7 and the mapping block 8 to the safety controller 6. As a result of this, cost when constructing a system can be reduced since the system can be integrated without adding hardware except the safety controller 6.

Also, functions related to the safety controller 6 can be intensively combined into the single function block 7 to achieve a simple configuration. As a result of this, engineering cost can be reduced. Further, data necessary in the control system 100 among various data handled by the function block 7 can be selected arbitrarily in the mapping block 8. As a result of this, for example, unlike the case of using only a signal outputted from the safety controller 6 as a calculation result, only data which one wishes to use in the control system 100 can be selected properly. In addition, a simple operation of comparing a process value “PV” from the sensor 61 with plural threshold values is illustrated in the example of FIG. 3. However, in an actual plant, etc., there are many cases where calculation in a complicated process must be performed using signals from many sensors, and in such cases, the number of data handled by the function block 7 increases. As a result of this, an advantage of the mapping block 8 capable of easily selecting any data without imposing a burden on engineering becomes very important. Also, when the number of signals from sensors which one wishes to use in the control system 100 increases, it becomes difficult to install wiring from the sensors to the control system 100 in a cost aspect, but according to the present embodiment, such a problem can also be solved effectively.

Also, in the embodiment described above, not only data used in the function block 7 is fetched but also processing of management and generation of a process alarm is performed by using a part of that data in the mapping block 8. As a result of this, control in a wide range including the process alarm can be performed as well as access to data related to the function inherent to the safety controller 6 in the control system 100. Also, by assigning a common tag to data related to the process alarm and data related to the function block 7, a group of these data can be recognized as one group of data related to one another in the control system 100, so that these data can be used effectively. Also, operation cost in the case of accessing necessary data can be reduced. Further, in the case of constructing a system, simply assigning the common tag to these data is sufficient, so that a burden on engineering is not increased in this respect.

In the embodiment described above, the mapping block 8 is implemented using a function of the controller 6 by software, but the mapping block may be constructed by using hardware such as a data server or a dedicated gateway.

Also, in the embodiment described above, the method for identifying a group of data by a tag as the control system 100 is used, but the invention can also be applied to the case of using other operation methods. Methods for associating data can be selected properly.

The applicable scope of the invention is not limited to the embodiment described above. The invention is not limited to an application to a control system for controlling a plant, and can widely be applied to the case of integrating two different systems.

The present application is based on Japanese patent application (patent application No. 2004-255080) filed on Sep. 2, 2004, and the contents of the patent application are hereby incorporated by reference.

1. An integration system for integrating a first system and a second system, wherein the first system comprises:
a function block for executing a function of the first system; and
a mapping block for converting data to be used in the second system among data handled by the function block into a data format which can be directly handled by the second system, and outputting the data by making the data be related to one another, and
wherein a data format of the data handled by the function block of the first system and the data format of the data handled by the second system are different.

2. The integration system as claimed in claim 1, wherein the mapping block performs calculation using the data handled by the function block and outputs the calculation result in the data format which can be directly handled by the second system.

3. An integration system for integrating a first system and a second system, wherein the first system comprises:
a function block for executing a function of the first system; and
a mapping block for performing calculation using data handled by the function block and outputting the calculation result in a data format which can be directly handled by the second system, and
wherein a data format of the data handled by the function block of the first system and the data format of the data handled by the second system are different.

4. The integration system as claimed in claim 1, wherein the second system is a control system for controlling a plant.

5. The integration system as claimed in claim 3, wherein the second system is a control system for controlling a plant.

6. The integration system as claimed in claim 4, wherein the first system is a system for ensuring safety of the plant.

7. The integration system as claimed in claim 5, wherein the first system is a system for ensuring safety of the plant.

8. A system integration method for integrating a first system and a second system, the system integration method comprising the steps of:
executing a function of the first system by using a function block; and
converting data to be used in the second system among data handled by the function block into a data format which can be directly handled by the second system, and outputting the data by making the data be related to one another,
wherein a data format of the data handled by the function block that executes the function of the first system and the data format of the data handled by the second system are different.

9. The system integration method as claimed in claim 8, comprising the step of:
performing calculation using the data handled by the function block and outputting the calculation result in the data format which can be directly handled by the second system.

10. A system integration method for integrating a first system and a second system, the system integration method comprising the steps of:
executing a function of the first system by using a function block; and
performing calculation using data handled by the function block and outputting the calculation result in a data format which can be directly handled by the second system,
wherein a data format of the data handled by the function block that executes the function of the first system and the data format of the data handled by the second system are different.

11. The system integration method as claimed in claim 8, wherein the second system is a control system for controlling a plant.

12. The system integration method as claimed in claim 10, wherein the second system is a control system for controlling a plant.

13. The system integration method as claimed in claim 11, wherein the first system is a system for ensuring safety of the plant.

14. The system integration method as claimed in claim 12, wherein the first system is a system for ensuring safety of the plant.

15. A computer readable medium having a system integration program for executing a system integration method for integrating a first system and a second system, the system integration program allowing a computer to execute the steps of:
executing a function of the first system by using a function block; and
converting data to be used in the second system among data handled by the function block into a data format which can be directly handled by the second system, and outputting the data by making the data be related to one another,
wherein a data format of the data handled by the function block that executes the function of the first system and the data format of the data handled by the second system are different.

16. The computer readable medium as claimed in claim 15, wherein the system integration program allows a computer to execute the step of:
performing calculation using the data handled by the function block, and outputting the calculation result in the data format which can be directly handled by the second system.

17. A computer readable medium having a system integration program for executing a system integration method for integrating a first system and a second system, the system integration program allowing a computer to execute the steps of:
executing a function of the first system by using a function block; and
performing calculation using data handled by the function block, and outputting the calculation result in a data format which can be directly handled by the second system,
wherein a data format of the data handled by the function block that executes the function of the first system and the data format of the data handled by the second system are different.
